(19) United States
(12) Patent Application Publication
(10) Pub. No.: US 2002/0080495 A1
(43) Pub. Date: Jun. 27, 2002

(54) Method and apparatus for reducing distortion in a displayed image

(75) Inventor: Douglas W. Anderson, Richardson, TX (US)

Correspondence Address: Jerry W. Mills, Baker Botts L.L.P., 2001 Ross Avenue, Dallas, TX, 75201-2980, US

(73) Assignee: Raytheon Company

(21) Appl. No.: 09/747,035

(22) Filed: Dec. 21, 2000

(51) Int. Cl. G02B 27/14; G02B 3/08

(52) U.S. Cl. 359/630; 359/632; 359/742

(57) ABSTRACT

A vehicle (10) includes an infrared imaging system, which has a collection device (22) that collects infrared radiation and supplies it through a cable (24) to a head-up display (27). The head-up display includes an image generator (41) which produces a visible image corresponding to information collected by the collecting device, a lens (43) through which the visible image passes, and a reflector (46). The reflector is a portion of the vehicle windshield (14), and reflects the visible image toward the eyes of a driver (11). The lens has on one side a Fresnel lens surface (56) with a rotationally symmetric power, and has on the opposite side a Fresnel lens surface (57) with a cylindrical power that compensates for asymmetric factors such as the curvature and tilt of the windshield.

### BACKGROUND OF THE INVENTION

In recent years, automobiles have been commercially marketed which include an infrared imaging system. The infrared imaging system generates for the driver a visible image representing thermal information from the same scene which the driver is directly observing through the windshield. The infrared imaging system has a distance range which is greater than that of the vehicle's headlights, and can thus be used at night to detect animals or objects which are beyond the range of the vehicle's headlights. For example, if a deer has wandered into the road ahead, but is beyond the range of illumination of the vehicle's headlights, the infrared imaging system can provide the driver with notice of the presence of the deer well before the driver can see the deer with his or her eyes.

While infrared imaging systems of this known type have been generally adequate for their intended purposes, they have not been satisfactory in all respects. In this regard, these infrared imaging systems typically produce an image for the driver by using part of the lower portion of the vehicle's windshield as a reflector. Virtually all vehicle windshields have an asymmetric curvature which imparts a degree of distortion to the visible image at the time it is reflected. Further, the windshield also typically has an angle of tilt that can impart a further level of distortion to the image which is reflected. A related consideration is that various different types of vehicles will have windshields with entirely different curvatures, depending on the structure and exterior styling of the particular vehicle. Moreover, glass production techniques and typical current manufacturing tolerances for windshields are such that, even for a given vehicle model, there is often some degree of variation between windshields for that model which are supposedly identical.

### SUMMARY OF THE INVENTION

From the foregoing, it may be appreciated that a need has arisen for a method and apparatus for reducing distortion in a display arrangement where a visible image is reflected from a non-planar reflector. According to the present invention, a method and apparatus are provided to address this need, and involve: generating a visible image; reflecting the visible image toward a viewing location using a reflector which is non-planar; and directing the visible image through a lens section as the visible image travels to the viewing location, the lens section including first and second portions which each modify the visible image, the first portion having a power which facilitates an imaging function, and the second portion having a cylindrical power.

### BRIEF DESCRIPTION OF THE DRAWINGS

A better understanding of the present invention will be realized from the detailed description which follows, taken in conjunction with the accompanying drawings, in which:

FIG. 1 is a diagrammatic top view of a vehicle having an infrared imaging system that includes a head-up display which embodies the present invention;

FIG. 2 is a diagrammatic side view of the vehicle of FIG. 1, showing the head-up display disposed within the vehicle;

FIG. 3 is a diagrammatic side view of the vehicle of FIG. 1, and is a portion of FIG. 2 shown in an enlarged scale; and

FIGS. 4 and 5 are diagrammatic views of respective Fresnel lens surfaces that are disposed on opposite sides of a lens element, the lens element being a component of the head-up display from the vehicle of FIG. 1.

### DETAILED DESCRIPTION OF THE INVENTION

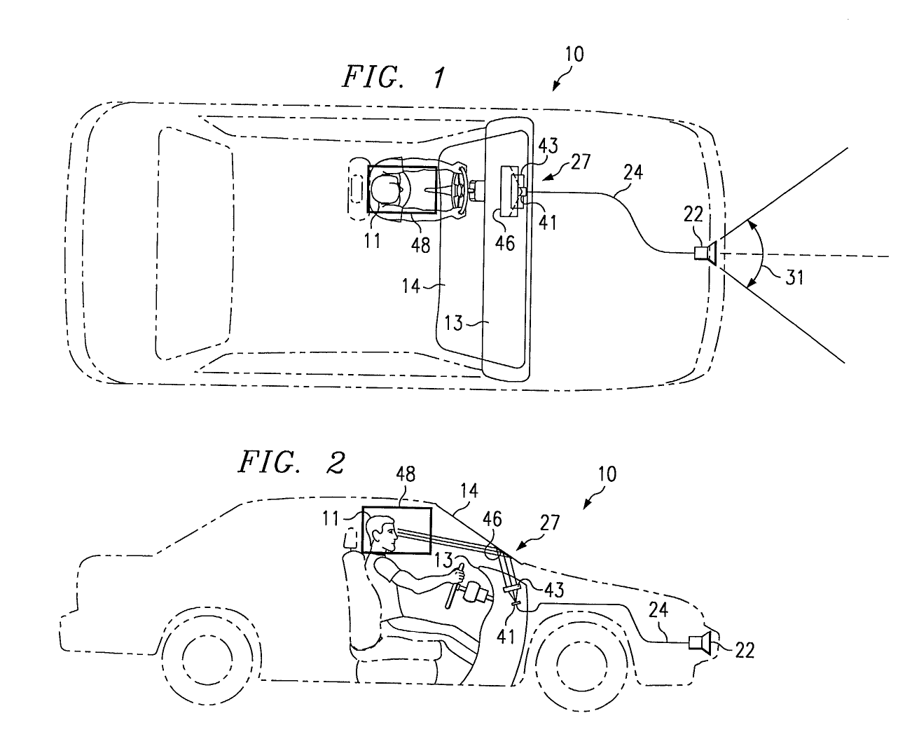

FIG. 1 is a diagrammatic top view of a vehicle 10 which embodies the present invention, and which may be operated by a driver 11. FIG. 2 is a diagrammatic side view of the vehicle 10, and FIG. 3 is a diagrammatic view in an enlarged scale of a portion of the side view of FIG. 2.

The vehicle 10 has an infrared imaging system, which includes a collection device 22 coupled by an electrical cable 24 to a head-up display (HUD) 27. The infrared imaging system 10 assists the driver in seeing animals or objects which may be difficult or impossible to see with the naked eye. As one example, when the vehicle is being driven at night, an animal such as a deer may wander into the road at distance sufficiently far from the vehicle so that the animal is beyond the illumination of the vehicle's headlights. The infrared imaging system can detect thermal energy emitted by the animal, and provide a visible image to the driver, so that the driver is aware of the presence of something even before the driver can actually see the deer with his or her naked eye. This capability adds a significant degree of safety to night driving.

The collection device 22, which is also commonly called an infrared camera, is an apparatus of a type known to those skilled in the art. It collects infrared energy emitted in front of the vehicle 10 within a field-of-view (FOV) 31. In the disclosed embodiment, the collection device 22 captures a series of successive two-dimensional thermal images or frames, converts each such image into electrical signals, and then transmits these electrical signals through the cable 24 to the head-up display 27.

The head-up display 27 includes an image generator 41, a lens 43, and a reflector 46. The image generator accepts the electrical signals supplied by the collection device 22 through the cable 24, and converts them into visible images in a known manner. These visible images from the image generator 41 then pass through the lens 43, and are thereafter reflected toward the eyes of the driver 11 by the reflector 46. FIGS. 1-3 show an eyebox 48, which represents an imaginary three-dimensional volume. While driving, the driver can move his or her head and, so long as his or her eyes both remain within the eyebox 48, the driver will have a good view of the entire visual image from the HUD 27. If the driver 11 moves his or her head outside of the eyebox 48, it may be that only a portion, if any, of the visual image from the HUD 27 will remain clearly viewable.

In the disclosed embodiment, the image generator 41 is a liquid crystal display. However, it could alternatively be a cathode ray tube (CRT), or any other electronic device that can generate a visual image. The image generator 41 of the disclosed embodiment uses monochromatic light to generate the visible image, in order to reduce chromatic aberrations that may be caused by polychromatic light. However, alternative arrangements could be used. For example, an image generator could produce images which include both monochromatic and polychromatic light, and a filter could be provided to filter the polychromatic light from the image in order to produce a pseudo-monochromatic image.

In the disclosed embodiment, the reflector 46 is a small portion of the windshield 14, located in a lower part of the windshield near the dashboard 13. The portion 46 of the windshield is thus disposed lower than the normal line of sight along which the driver 11 would view the road ahead through the windshield 14. Since the infrared imaging system is intended primarily for use at night, when it is dark outside the vehicle 10, the portion 46 of the windshield will be reasonably efficient in functioning like a mirror. In particular, images from the image generator 41 which have passed through the lens 43 will be reflected by the inner surface of the windshield in a direction toward a viewing location which is within the eyebox 48 and which corresponds to the eyes of the driver 11.

As is common in modern vehicles, the windshield 14 and the portion 46 thereof are curved, and in fact the portion 46 has an asymmetrical curvature. This asymmetrical curvature imparts a degree of distortion to the image at the time the image is reflected. A further consideration is that the angle of tilt of the windshield varies from vehicle to vehicle, and is normally selected to achieve design goals of aesthetic styling and reduced wind resistance. Consequently, the angle of tilt of the portion 46 of the windshield is typically not an angle that is optimum for reflecting an image toward the eyes of the driver. This is a further factor which introduces a degree of distortion into the image at the time that the image is reflected. The tilt of the windshield can also have the effect of shifting the apparent focus, and foreshortening the image. As discussed in more detail below, the lens 43 provides compensation for these types of factors in order to reduce corresponding distortion.

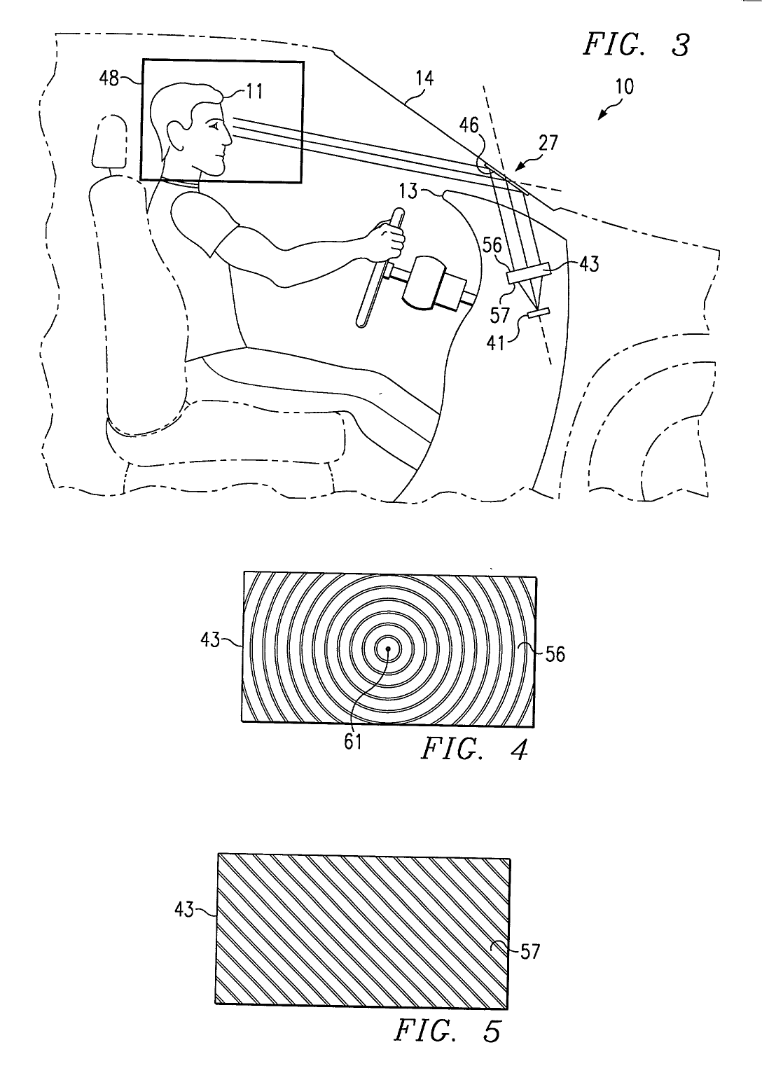

More specifically, FIGS. 4 and 5 show the lens 43 in greater detail, where FIG. 4 is a diagrammatic view of a Fresnel lens surface 56 provided on the top of the lens 43, and FIG. 5 is a diagrammatic view of a different Fresnel lens surface 57 provided on the bottom of the lens 43. In the disclosed embodiment, the lens 43 is approximately rectangular, but it will be recognized that a variety of other shapes could alternatively be used.

In the disclosed embodiment, both sides of the lens 43 are Fresnel lens surfaces. However, it would alternatively be possible to implement the present invention using standard lens surfaces with appropriate curvatures, rather than Fresnel lens surfaces. Further, instead of providing the two lens surfaces on opposite sides of a single lens element, it would be possible to provide the two lens surfaces on separate lens elements. However, by using Fresnel lens surfaces according to the disclosed embodiment, and by providing both of these surfaces on opposite sides of a single lens element, the resulting lens 43 is smaller, lighter and cheaper to manufacture than would otherwise be the case. In the context of a consumer product such as the vehicle 10, it is desirable to minimize size, weight and cost. Further, since there is a limited amount of space within the dashboard 13 of most vehicles, it is highly desirable to have the smallest possible size for each component of the head-up display 27, including the lens 43.

Referring to FIG. 4, the Fresnel lens surface 56 on the top side of the lens 43 provides a rotationally symmetrical power. This Fresnel lens surface 56 is of a type known to those skilled in the art, and includes a plurality of circular grooves of different diameters which concentrically encircle a center axis 61. The top surface 56 of the lens 43 refracts the visible image from the image generator 41 in a symmetric matter, so as to achieve design criteria such as producing a virtual image at an appropriate location, while maintaining an appropriate size for the image so that there is substantially a one-to-one relationship between the image of the scene ahead as observed by the driver 11 through the windshield, and the image of the same scene as observed by the driver from the HUD 27.

As discussed above, the portion 46 of the windshield 14 has an angle of tilt and an asymmetric curvature which introduce a degree of distortion into the visible image at the time it is reflected. The rotationally symmetric power provided by the Fresnel lens surface 56 on the top of the lens 43 does not provide any correction for factors such as the curvature and tilt of the windshield 14. Some non-symmetric correction could conceivably be achieved by tilting and decentering the rotationally symmetric Fresnel lens surface 56, but the amount of such correction is limited by the fact that such a decentered surface must have a faster f-number than a centered element, and Fresnel lenses are limited to about f/0.7 or greater. The present invention therefore takes the approach of adding the cylindrically powered Fresnel lens surface 57.

More specifically, the Fresnel lens surface 57 is provided on the bottom of the lens 43 in order to produce a cylindrical power which modifies the visible image in a manner that compensates for effects of the tilt and curvature of the windshield. In particular, the Fresnel lens surface 57 includes a plurality of parallel grooves that provide an appropriate cylindrical power for the associated windshield.

In this regard, it will be recognized that the curvature and tilt of vehicle windshields varies widely from one vehicle model to another. For example, the curvature and tilt of a windshield in a sedan will typically differ from the curvature and tilt of a windshield in a sport utility vehicle (SUV), which in turn will typically differ from the curvature and tilt of a windshield in a pick-up truck. In fact, the curvature and tilt of a windshield in one sedan model will typically differ from the curvature and tilt of a windshield in a different sedan model. Consequently, the present application does not provide an exact definition of each of the Fresnel lens surfaces 56 and 57 of the lens 43, because appropriate definitions for these surfaces will typically be different for each vehicle model. Persons skilled in the art understand the techniques needed to generate appropriate Fresnel lens surfaces for a given vehicle model.

As discussed above, the lens 43 in the disclosed embodiment is configured so that an image from the image generator 41 first passes through the Fresnel lens surface 57 with the cylindrical power, and then through the Fresnel lens surface 56 with the rotationally symmetric power. In some applications, where a fast f number is needed, this configuration is advantageous, because the shape of the grooves for the Fresnel lens surface 56 with the rotationally symmetric power can be easier to manufacture if the grooves are on the long conjugate side of the lens 43. However, it is within the scope of the present invention to reverse the order in which the image passes through the Fresnel lens surfaces, for example by placing the surface with the rotationally symmetric power on the bottom side of the lens, and the surface with the cylindrical power on the top side of the lens.

The present invention provides a number of technical advantages. One such technical advantage results from the provision of a lens surface which has a cylindrical power, and which compensates for effects such as the curvature and tilt of a windshield used as a reflector. A further advantage is that the cylindrical power is implemented as a Fresnel lens surface, which serves to reduce the size, weight and cost of the lens that provides the cylindrical power. Still another advantage is that the Fresnel lens surface which provides the cylindrical power and the Fresnel lens surface which provides the rotationally symmetric power are provided on opposite sides of a single lens, which also serves to minimize size and weight, and permits this single lens element to be made by inexpensive techniques such as an injection molding process. Still another advantage results where images first pass through the Fresnel lens surface with the cylindrical power, and then pass through the Fresnel lens surface with the rotationally symmetric power, because for some applications the lens can be manufactured more easily and cheaply.

A further advantage is that the cylindrical power helps flatten out the apparent or virtual image presented to the driver, thereby reducing potential eyestrain and making it more comfortable for the driver to view the virtual image from the HUD. Yet another advantage is that the disclosed HUD provides a relatively large eyebox, and a relatively wide field of view. It achieves improved optical performance by separately correcting the non-symmetric aberration of the windshield with a cylindrically powered Fresnel lens surface, while using a rotationally symmetric Fresnel lens surface for the primary imaging function. The improved optical performance includes reduced distortion and reduced vertical disparity. Still another advantage is that the present invention provides improvement with respect to dipvergence. Further, the HUD according to the invention permits proper mapping, in particular by allowing a one-to-one ratio between the actual visual image seen by the driver through the windshield, and the thermal image of that same scene provided by the HUD.

Although one embodiment has been illustrated and described in detail, it will be understood that various substitutions and alterations can be made therein without departing from the scope of the present invention. For example, the disclosed embodiment involves a head-up display installed in a vehicle, but it will be recognized that the present invention can be used in environments other than a vehicle or a head-up display. Further, the disclosed embodiment uses two Fresnel lens surfaces, but it will be recognized that either or both of these surfaces could be implemented with an appropriate standard curved lens surface. Further, both lens surfaces are provided on opposite sides of a single lens element, but it will be recognized that they could alternatively be provided on separate lens elements. Moreover, the image in the disclosed embodiment passes successively through the Fresnel lens surface with the cylindrical power and then the Fresnel lens surface with the rotationally symmetric power, but it will be recognized that it would be possible to reverse the order in which the image encounters these surfaces.

A further consideration is that, in the disclosed embodiment, the visible image travels from the image generator through the lens to a reflector, but for certain applications it would be possible to rearrange the optical order of the various elements in the HUD. Also, even though the reflector in the disclosed embodiment is a windshield, it will be recognized that the present application can be utilized in conjunction with a variety of other types of reflectors to compensate for factors such as tilt and/or curvature. Other substitutions and alterations are also possible without departing from the spirit and scope of the present invention, as defined by the following claims.

What is claimed is:

1. An apparatus, comprising:
an image generator which generates a visible image;
a reflector which is non-planar and which reflects the visible image toward a viewing location; and
a lens section disposed so that the visible image passes through said lens section as the visible image travels from said image generator to the viewing location, said lens section including first and second portions which each modify the visible image, said first portion having a power which facilitates an imaging function, and said second portion having a cylindrical power.

2. An apparatus according to claim 1, wherein said lens section is disposed so that the visible image passes through said lens section as the visible image travels from said image generator to said reflector.

3. An apparatus according to claim 1, wherein said first portion has a rotationally symmetric power.

4. An apparatus according to claim 1, wherein said second portion modifies the visible image in a manner which at least partly compensates for the non-planar shape of said reflector.

5. An apparatus according to claim 1, wherein said second portion modifies the visible image in a manner which at least partly compensates for a tilt angle of said reflector relative to a path of travel of the visible image.

6. An apparatus according to claim 1, wherein said second portion is a Fresnel lens surface.

7. An apparatus according to claim 6, wherein said first portion is a Fresnel lens surface having a rotationally symmetric power.

8. An apparatus according to claim 1, wherein said lens section includes a lens, and wherein said first and second portions are respective surfaces disposed on opposite sides of said lens.

9. An apparatus according to claim 8, wherein said surface corresponding to said second portion is a Fresnel lens surface.

10. An apparatus according to claim 9, wherein said surface corresponding to said first portion is a Fresnel lens surface having a rotationally symmetric power.

11. An apparatus according to claim 1, wherein said reflector has an asymmetric curvature.

12. An apparatus according to claim 1, including a vehicle having a windshield, said image generator and said lens section being disposed in said vehicle, and said reflector being a portion of said windshield.

13. An apparatus according to claim 1, including a collection device for collecting infrared radiation, and for supplying to said image generator electrical signals which are representative of the collected infrared radiation, said image generator converting the electrical signals into the visible image.

14. A method, comprising the steps of:
generating a visible image;
reflecting the visible image toward a viewing location using a reflector which is non-planar; and
directing the visible image through a lens section as the visible image travels to the viewing location, said lens section including first and second portions which each modify the visible image, said first portion having a power which facilitates an imaging function, and said second portion having a cylindrical power.

15. A method according to claim 14, wherein said directing step includes the step of causing the visible image to pass through said lens section before the visible image reaches said reflector.

16. An apparatus according to claim 14, including the step of configuring said first portion to have a rotationally symmetric power.

17. A method according to claim 14, including the step of causing said second portion to modify the visible image in a manner which at least partly compensates for the non-planar shape of said reflector.

18. A method according to claim 14, wherein the non-planar shape of said reflector includes said reflector having an asymmetric curvature, and including the step of causing said second portion to modify the visible image in a manner which at least partly compensates for the asymmetric curvature of said reflector.

19. A method according to claim 14, including the step of causing said second portion to modify the visible image in a manner which at least partly compensates for a tilt angle of said reflector relative to a path of travel of the visible image.

20. A method according to claim 14, including the step of implementing said second portion with a Fresnel lens surface.

21. A method according to claim 20, including the step of implementing said first portion with a Fresnel lens surface having a rotationally symmetric power.

22. A method according to claim 21, including the step of providing said Fresnel lens surfaces on opposite sides of a single lens.
